(19) United States
(12) Patent Application Publication
(10) Pub. No.: US 2009/0261802 A1
(43) Pub. Date: Oct. 22, 2009

(54) SIMULATOR SYSTEM AND METHOD FOR MEASURING ACCEPTANCE ANGLE CHARACTERISTICS OF A SOLAR CONCENTRATOR

(75) Inventors: Steve Askins, Ledyard, CT (US); Sean Taylor, Mountain View, CA (US)

Correspondence Address: THE MUELLER LAW OFFICE, P.C., 12951 Harwick Lane, San Diego, CA, 92130, US

(73) Assignee: SOLFOCUS, INC., Mountain View, CA (US)

(21) Appl. No.: 12/202,378

(22) Filed: Sep. 1, 2008

Related U.S. Application Data
(60) Provisional application No. 61/047,090, filed on Apr. 22, 2008.

(51) Int. Cl. G01B 7/30

(52) U.S. Cl. 324/71.1

(57) ABSTRACT

A simulator system for simulating operation of a solar module comprises a frame for holding the solar module in a testing position, a light source positioned adjacent to the solar module for directing light from the light source to the solar module, and a movable assembly for simulating movement of a solar tracker system, wherein the movable assembly moves in two axes to change an incident angle of the light with respect to the testing position of the solar module.

This application claims priority to U.S. Provisional patent application No. 61/047,090 that was filed on Apr. 22, 2008, which is incorporated herein by this reference.

### BACKGROUND OF THE DISCLOSURE

The present disclosure is related to a simulator system for simulating operation of a solar module and more particularly to a simulator system for measuring acceptance angle characteristics of a solar concentrator.

Solar power is the collection or harvesting of solar energy and converting the energy into electricity that may be used to power various devices. A particular type of device used in a solar system is a solar collector or a solar module that employs a photovoltaic cell. The photovoltaic cell is used to convert the impinging solar energy into electrical power.

In the development of solar collectors or modules it is important to be able to test the performance of such collectors in an indoor setting. While field testing ultimately needs to be performed on a final design, indoor testing, such as in a laboratory setting or manufacturing environment, can provide more repeatable test conditions, speed development cycles, and be used for factory testing of modules during production. In one aspect of testing solar collectors, and in particular concentrator photovoltaic (CPV) modules, it is important to characterize peak power. Measuring the peak power requires the ability to measure a current-voltage (I-V) curve. An I-V curve describes the behavior of a solar module in terms of photocurrent produced at different voltage loads. This behavior is dependent on the temperature of the cells and the irradiance (flux of light in Watts per square meter).

In another aspect of testing CPV modules, it is important to characterize the acceptance angle. The acceptance angle is defined as the angular amount that such modules can be rotated away from an orientation where their optical axis is aligned with the vector of the incoming light (the vector pointing at the center of the sun), before the power they produce drops by some set percentage of the maximum power produced when perfectly aligned. Although CPV modules by definition will have a relatively low acceptance angle compared to non-concentrating devices, it is important that the CPV module has as high an acceptance angle as possible so that inaccuracies in the solar tracking system don't result in power loss. The acceptance angle is often highly dependent on mechanical assembly tolerances in production. Therefore the acceptance angle must be characterized both in research settings to evaluate new designs, as well as in production settings, to verify that module being produced have the required acceptance angle.

Technical requirements for testing CPV modules are more stringent than for flat-plate photovoltaic testers for two reasons. First, the light source must be highly collimated; that is, parallel to itself. If acceptance angle is to be tested, it is even more important that the angular size of the source (the apparent angle filled by the source as viewed by the module) matches that of the sun as seen from the earth, so that off-axis behavior corresponds to performance in normal operation. Secondly, CPV's typically use triple-junction solar cells. Triple-junction cell performance is more dependent on spectrum. Specifically, the light that exposes the modules must have the same ratio as sunlight between the energy in two specific bands of spectra: the portion harvested by the top junction and the portion harvested by the middle junction.

Thus, there exists a need for a solar simulator which can accurately test the performance of CPV modules. Other aspects such as improving the efficiency of taking measurements, accommodating various sizes and layouts of modules, and enabling solar simulators to be built in a reliable fashion can further improve the performance and commercialization of solar simulators.

### SUMMARY OF THE DISCLOSURE

In one form of the present disclosure, a system for testing the performance of a CPV module under simulated solar conditions is disclosed which comprises a frame for holding the solar module in a testing position, a light source positioned adjacent to the solar module for directing light from the light source to the solar module, and a movable assembly for simulating the inaccuracy of a solar tracker system, wherein the movable assembly moves in two axes to change an incident angle of the light with respect to the testing position of the solar module.

In another form of the present disclosure a method for testing the performance of a CPV module under simulated solar conditions comprises the steps of providing a frame for holding the solar module in a testing position, positioning a light source adjacent to the frame for directing light from the light source to the solar module, and providing a movable assembly to simulate the inaccuracy of a solar tracker system, wherein the assembly moves in two axes to change the incident angle of the light with respect to the testing position of the solar module.

Accordingly, a simulator system for measuring acceptance angle characteristics of a solar concentrator is provided. The present invention also provides a simulator system for measuring acceptance angle characteristics of a solar concentrator which can be easily employed with highly reliable results. The simulator system utilizes one or more optical elements to collimate light from a flash light source, which irradiates one or more concentrator photovoltaic modules to be tested. Also, structures and methods for allowing measurement of acceptance angle are described, involving movement either of the test modules or the light source.

These and other advantages of the present disclosure will become apparent after considering the following detailed specification in conjunction with the accompanying drawings.

### BRIEF DESCRIPTION OF THE DRAWINGS

FIG. 1 is a top plan view of a simulator system for simulating operation of a solar concentrator constructed according to the present disclosure;

FIG. 2 is a top plan view of the simulator system for simulating operation of a solar concentrator shown in FIG. 1 with the light source being translated;

FIG. 3 is a top plan view of an embodiment of a simulator system for simulating operation of a solar concentrator constructed according to the present disclosure;

FIG. 4 is a front view of another embodiment of a simulator system for simulating operation of a solar concentrator constructed according to the present disclosure;

FIG. 5 is a front view of another embodiment of a simulator system for simulating operation of a solar concentrator constructed according to the present disclosure;

FIG. 6 is a top view of the simulator system shown in FIG. 5;

FIG. 7 is a top view of the simulator system shown in FIG. 5 with the simulator system in an off axes position; and

FIG. 8 is a block diagram of another embodiment of a simulator system for measuring acceptance angle characteristics of a solar concentrator constructed according to the present disclosure.

### DETAILED DESCRIPTION OF THE EMBODIMENTS

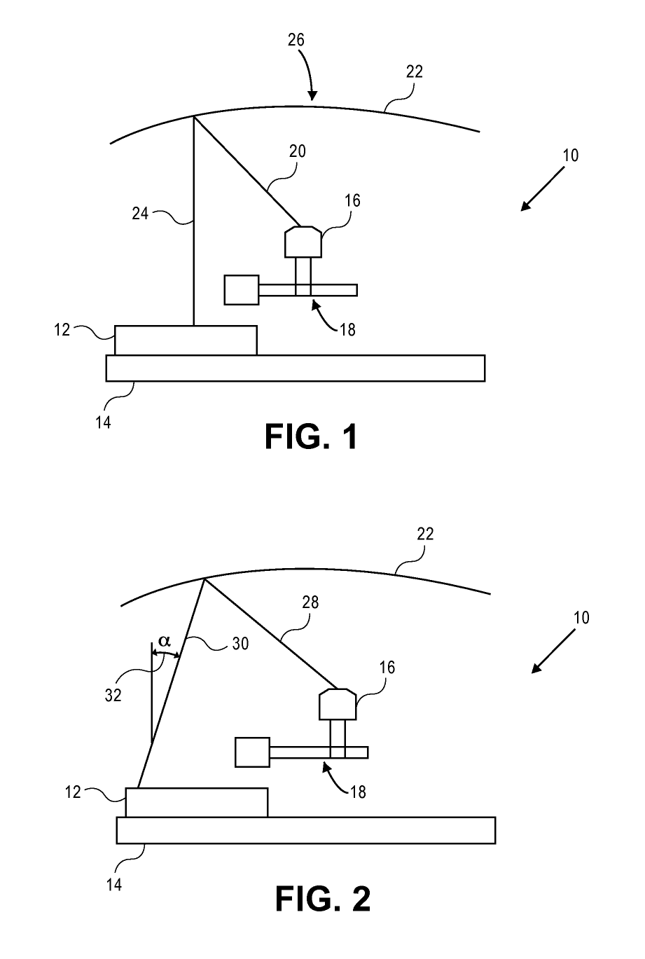

The current invention provides collimated light that matches the angular size of the sun. In other words, the focal length is substantially matched to the light source size. By matching the apparent angular size of the light source of the sun, test results obtained by using artificial light, especially for estimates of acceptance angle, are more accurate in predicting the performance of that device when used outside in the sunlight. Referring now to the drawings, wherein like numbers refer to like items, number 10 identifies an embodiment of a simulator system for measuring acceptance angle characteristics of a solar concentrator. The simulator system 10 is shown comprising a solar module 12, such as a solar concentrator device or CPV, which is mounted to a frame assembly 14. A light source 16 is mounted to a movable assembly 18 which may travel in a vertical position and a horizontal position. The light source 16 is capable of producing light such as divergent light, indicated as a light ray or beam 20, which is directed toward a collimator, a collimator optic, or a reflector 22. The reflector 22 is capable of reflecting a light ray or a collimating beam 24 toward the solar module 12. The collimated beam 24 is used to simulate the light from the sun, which is highly collimated. Once the solar module 12 is exposed to the collimated beam 24 the solar module 12 generates electricity. The movable assembly 18 may be a Cartesian or X-Y robot device that has the ability to move this light source 16 in a horizontal direction or position and a vertical direction or position with respect to the reflector 22. The movable assembly 18 may also simulates movement of a solar tracker system which is used to track the movement of the sun throughout the day. In the “home” position depicted in FIG. 1, the movable assembly 18 will place the light source 16 at the focus of the collimator so that the collimating beam 24 falls on the module 12 at an angle normal to the optical axis. The movable assembly 18 is also shown in an on-axis orientation in which the light source 16 is centered on a focus 26 of the reflector 22. In essence, the solar module 12 is perfectly aligned with the collimating beam 24 and in this position the module 12 is capable of generating its maximum power.

The light source 16 may be a commercial photographic flash strobe or tube, such as a xenon flash strobe that produces a pulse of light. The xenon flash strobe combines high intensity, for a very brief period, with a small overall light source size. With a smaller light source, the required focal distance to achieve the desired collimation is reduced. In addition, the lamp intensity requirement to achieve specific module irradiance is decreased. That is, the closer the light source 16 is to the reflector 22, the brighter the beam of collimated light 24 will be. For example, in FIG. 1 the focal distance for this system 10 is 6.97 meters so that the angular size of a 65 mm diameter flash tube is 0.267°.

The collimator 22 may be a spherical mirror which may be made of slumped, ground, and polished glass. Although a reflective type of collimator has been described, it is also possible and contemplated to use all types of collimators whether they use reflection (e.g. spherical or parabolic reflector), refraction, or diffraction. For instance, other possible embodiments are a reflective lens, a simple lens, a fresnel lens, or an off-axis reflective lens.

An important performance characteristic of CPV modules, such as the solar module 12, is their acceptance angle. The acceptance angle is defined as the angular amount that such panels can be rotated away from an orientation where their optical axis is aligned with the vector of the incoming light (the vector pointing at the center of the sun), before the power they produce drops by some set percentage of the maximum power produced when perfectly aligned. In order to measure the acceptance angle of the solar module 12, the movable assembly 18 is repositioned in the horizontal position, the vertical position, or both.

With reference now to FIG. 2, the movable assembly 18 has been translated in one direction, for example the positive x direction in the Cartesian coordinate system, resulting in an off-axis configuration. This movement changes the angle at which the divergent light ray 28 strikes the collimating optic 22. The resulting collimating ray 30 strikes the solar module at an angle 32 with the angle 32 also being represented by the letter “α”. For the system 10 having a focal distance “f,” the distance “d” to move the light source 16 to achieve a desired change in angle of incidence α is computed by d=f*sin(α).

Although not shown, the solar module 12 and the movable assembly 18 may be connected to a circuit or other control device that includes appropriate hardware and software that is capable of measuring one or more I-V curves associated with the light 24 striking the module 12 and performance of the module 12. In this manner various I-V curves are generated to determine the power produced by the module 12. In particular, when the movable assembly 18 is in the on-axis position, as shown in FIG. 1, the light source 16 is illuminated and a first I-V curve is determined which can correspond to the maximum power that can be generated by the module 12. The control device can then translate the movable assembly 18 and the light source 16 a distance then illuminate the light source 16 and produce a second I-V curve. Movement of the light source 16 is illustrated in FIG. 2. The second I-V curve can correspond to something less than the maximum power. The control device can perform this task a number of times until it is determined that the power being generated has dropped by some set percentage of the maximum power produced when perfectly aligned. In this manner the acceptance angle of the module 12 may be measured or estimated.

One advantage of using the movable assembly 18 in this embodiment is that the acceptance angle of the solar module 12 can be tested without rotating the module 12. The module 12 may be large and heavy, and therefore it is easier, less complex, and faster to translate the light source 16 than to rotate the module 12. If the module 12 does not have to be rotated at all, then no special structure for holding it may be required. For instance, if the solar module 12 does not need to be mounted on a special structure, the solar simulator system 10 could be oriented vertically, and the module 12 may pass by on a conveyor system. The module 12 could stop and be measured at many different angles without having to leave the conveyor system.

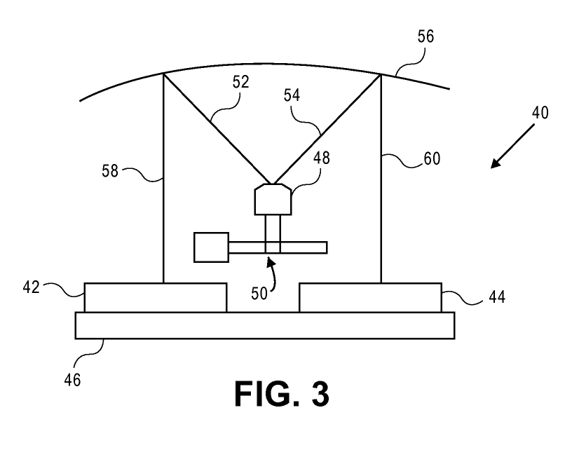

FIG. 3 illustrates a simulator system 40 used for testing acceptance angles for a pair of solar modules 42 and 44. The modules 42 and 44 are mounted to a frame assembly 46. A light source 48 is mounted to a movable assembly 50 which is capable of positioning the light source 48 in a vertical direction and a horizontal direction. The light source 48 directs light beams 52 and 54 toward a reflector 56. The reflector 56 reflects collimated light beams 58 and 60 toward the solar modules 42 and 44, respectively. The modules 42 and 44 are shown to be mounted normal to the axis of the reflector 56, but it is also possible that the modules 42 and 44 may be slightly at an angle to this axis. In order to test the acceptance angles for both of the solar modules 42 and 44, the movable assembly 50 is translated. In this manner, the two solar modules 42 and 44 may have their acceptance angles measured simultaneously. The ability to test two modules at the same time decreases the per-module testing time and cost. Further, as has been described, the solar modules 42 and 44 may be mounted on a conveyor system which may be positioned in the system 40 to measure the acceptance angles of each of the modules 42 and 44. Other solar modules may be mounted to the conveyor system for testing or measuring the acceptance angles of each of the modules in an assembly line like method.

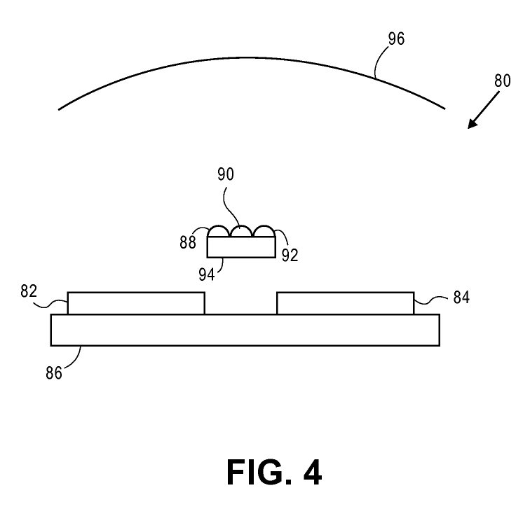

Referring now to FIG. 4, another embodiment of a simulator system 80 for testing the acceptance angles for a pair of solar modules 82 and 84 is shown. The modules 82 and 84 are mounted to a frame assembly 86. Three light sources 88, 90, and 92 are mounted to a stationary assembly 94 in which the light sources 88, 90, and 92 are in off-axis positions to create varying incident angles similar to the translating light source 16 shown in FIGS. 1 and 2. Each of the light sources 88, 90, and 92 are flashed in a sequence to measure the performance of the modules 82 and 84 at the corresponding incident angle. The simulator system 80 also comprises a collimator 96 for transforming divergent light beams into collimated light beams which are incident onto the solar module 82. The collimator 96 is also used to reflect light beams into light beams to the solar module 84. The simulator system 80 uses the multiple light sources 88, 90, and 92 instead of the single light source 16 mounted on the two-axis actuator 18 as shown in FIGS. 1 and 2. Each of the light sources 88, 90, and 92 must be correlated to have identical characteristics. Using this method, a test for angular acceptance can be quickly accomplished by having the light sources 88, 90, and 92 flashed on one after another with no pause for any of the light sources 88, 90, or 92 to be translated. The system 80 is useful when only discrete incidence angles are required to be measured, rather than an indefinite number of angles which can be achieved within a range of motion of the translating light source 16.

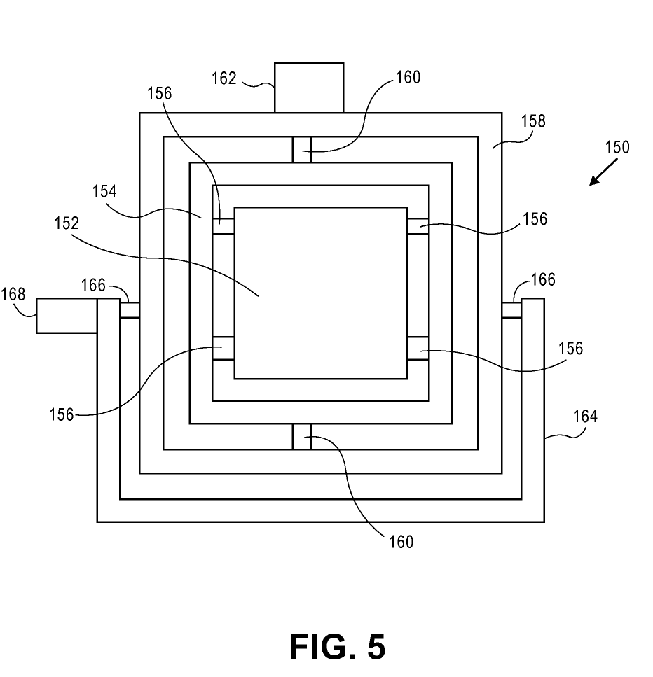

FIG. 5 is a front view of another embodiment of a simulator system 150 for measuring acceptance angle characteristics of a solar concentrator. The system 150 comprises a solar module 152, such as an CPV module, that is mounted on an inner motion frame 154 and held firmly in place via clamps 156. The inner motion frame 154 is attached to an outer motion frame 158 with bearings 160 which allow the inner motion frame 154 to rotate around the vertical axis. A yaw actuator 162 is attached to the outer motion frame 158 that is able to rotate or move the inner motion frame 154 around the vertical axis, or yaw, rotation. The outer motion frame 158 is then mounted to a base 164 on bearings 166 which allow the outer motion frame 158 to rotate around the horizontal axis. A pitch actuator 168 is mounted to the base 164 and when actuated will cause the outer motion frame 158 to move in the horizontal direction. The inner motion frame 154 and the outer motion frame 158 also simulate movement of a solar tracker system which is used to track the movement of the sun throughout the day. Although not depicted in FIG. 5, it should be understood that the system 150 also comprises a light source and a collimator that can provide collimated light on the surface of 152

The yaw actuator 162 and pitch actuator 168 may be electric motors, pneumatic cylinders, or any other device that can cause controlled rotation. Such actuators may allow for only a few rotational positions, such as a simple pneumatically-actuated system, or it may allow for any number of intermediate rotation positions to be tested, such as with a stepper motor. Other structures which allow the CPV module to be mounted and rotated around two orthogonal axes with respect to a beam of collimated light are possible and contemplated. Further, depending on the size of the CPV modules, the rotating frames 154 and 158 may necessarily be large, heavy structures. The rotating frames 154 and 158 may also need vibration control during movement, as well as re-alignment over time to prevent erroneous tests.

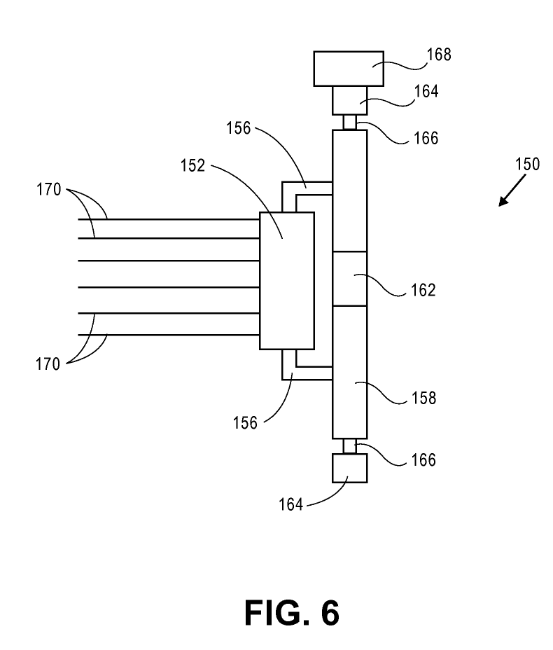

FIG. 6 shows the simulator system 150 in the home or an on-axis configuration. In this position the inner motion frame 154 and the outer motion frame 158 are centered within the base 164. The solar module 152 is positioned to receive collimating light beams or rays 170 in order to generate maximum power. In order to measure the acceptance angle of the solar module 152, the inner motion frame 154 may be moved in the vertical position by operation of the actuator 162 and the outer motion frame 158 may be moved in the horizontal position by operation of the actuator 168. The system 150 has the ability to rotate the module 152 in two axes so as to change the incident angle of the light 170 with respect to the optical axis of the module 152.

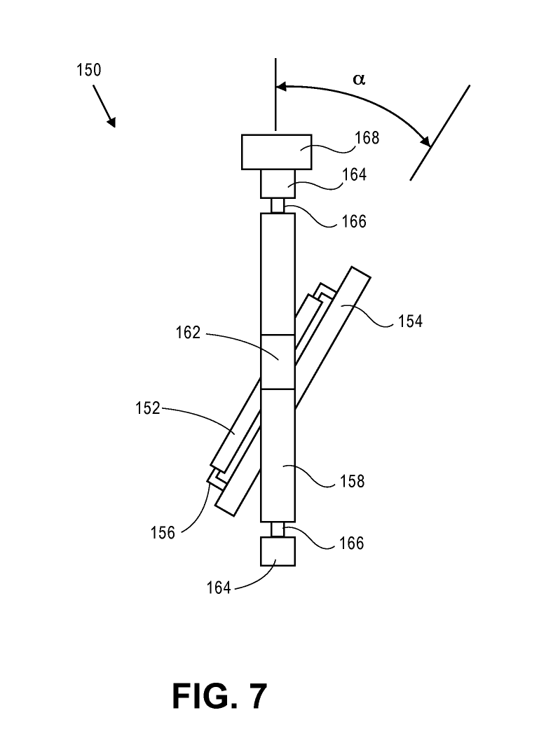

With particular reference to FIG. 7, the yaw actuator 162 of the simulator system 150 has been activated to move inner motion frame 154 and the solar module 152 into an off-axis configuration by an angle α. As has been described, it is also possible to operate the pitch actuator 168 to move the outer motion frame 158 and the solar module 152 into an off-axis configuration for testing the acceptance angle of the solar module 152.

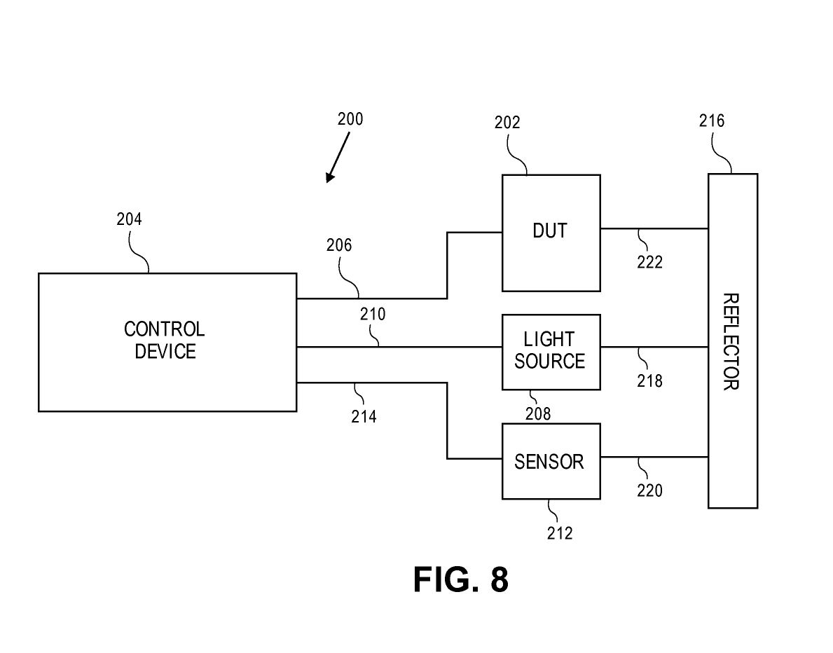

FIG. 8 illustrates a block diagram of a simulator system 200 for measuring acceptance angle characteristics of a solar concentrator. The simulator system 200 comprises a device under test (DUT) 202, such as a CPV module, connected to a control device 204 via an electrical connection 206. The simulator system 200 also comprises a light source 208 positioned adjacent to the DUT 202 with the light source 208 being electrically connected to the control device by a wire 210, and a sensor device 212 which is also connected to the control device by a wire 214. The control device 204 may include various components such as a microprocessor, a microcontroller or other similar control circuit, or a computer system having various storage devices, input devices, and output devices. A reflector 216 is positioned across from the DUT 202, the light source 208, and the sensor 212. The light source 208 may be placed at the focus of the reflector 216. Although not shown, it is also possible to test a second solar module in this particular arrangement. Various housings or assemblies for holding or positioning the DUT 202, control device 204, the light source 208, the sensor 212, and the reflector 216 have not been shown in this particular drawing.

To measure the acceptance angle characteristics of the DUT 202 the light source 208 is energized to produce a single flash of light 218 to be directed to the reflector 216. The light source 208 is operated under the control of the control device 204 by sending a signal over the connection 210. The reflector 216 reflects a collimated beam 220 to the sensor 212 and a collimated beam 222 to the DUT 202. The sensor 212 sends a signal indicative of the collimated beam 220 over the connection 214 to the control device 204. Once the signal is sent to the control device 204, the control device 204 processes the signal and then generates an I-V curve by receiving a signal over the connection 206 from the DUT 202. The signal produced by the DUT 202 is indicative of the collimated beam 222 received from the reflector 216. For example, the DUT 202 and the light source 208 may be aligned so that the DUT 202 receives the maximum power from the light source 208. Once the I-V curve is generated, it may be processed to estimate or determine an acceptance angle and this information may then be stored by the control device 204 for further processing.

Next, depending upon the various housings or assemblies employed by the simulator system 200, a signal may be sent from the control device 204 to control movement or positioning of the DUT 202 or the light source 208. For example, the movable assembly 18 of the system 10 may be used to translate the light source 208. Once the light source 208 has been repositioned the light source 208 is energized. The sensor 212 detects the light reflected from the reflector 216 and sends a signal indicative of the reflected light to the control device 204. The control device 204 processes this signal and then produces a second I-V curve. This second I-V curve is processed by the control device 204 to determine if the DUT 202 has an acceptance angle this is satisfactory or within accepted tolerances. Further testing may be accomplished by moving either the DUT 202 or the light source 208. The control device 204 may include software for controlling operation of the system 200 and for implementing the various steps or process just described.

The sensor 212 may be one or more reference irradiance detectors that may be used to measure the irradiance profile during the pulse of light. This measurement may be used for the purposes of adjusting the measured photocurrent, triggering a data acquisition circuit, or measuring the spectrum. In the system 200 which is used to test a CPV, the reference detector or sensor 212 must respond to light input similarly to the DUT 202 being tested. Otherwise, it is not a valid signal to use for normalization or for triggering. The reference power unit or sensor 212 is defined as a copy of the optics and solar cell assemblies that are tiled together to create a CPV module. By using the same cell and optics, configured to the same specifications as DUT 202, it is ensured that the angular acceptance of the reference power unit 212 will be the same or similar to the DUT 202. The reference power unit 212 will not erroneously include light that is falling on the DUT 202 and on the reference unit 212 at such an angle that it does not transmit through the module optics to the module cells. Furthermore, the spectral response of the reference power unit 212 will be similar to the test unit 202. Since the same solar cell and optical components are used in the reference 212 as in the test unit 202, the spectrum of light exposing the cell, which for the DUT 202 is the light transmitted through the optics rather than the light exposing the front of the module 202 will be the same. Lastly, the concentration of the light falling on the reference cell 212 will be similar to that falling on the cells of the test module 202. Because the cells operate differently at different concentrations of light, this further ensures a similar response between the reference 212 and the module 202.

Because each junction of the multi-junction cells which are often used for CPV modules typically respond to a separate, specific band of the spectrum, and because such junctions are electrically connected in a series circuit, it is important that the light used to expose such CPV modules has spectral characteristics similar to the sun. The spectrum need not exactly match the sun's, but the flux of the simulated light integrated across the bands to which each junction responds must have the correct ratio with that of the other junctions. The correct ratio is defined by the ratios extent in the solar light at the time of day, time of year, and geographic location that the test is intended to simulate. Furthermore, for CPV modules, the spectral transmission characteristic of the optics must be taken into account.

The system 200 is used for exposing the DUT 202 with collimated light of appropriate spectrum, measuring that light with one or more reference power units or sensors 212, measuring the I-V characteristics of the DUT 202 during a short flash, and finally altering the angle of incidence of the light on the DUT 202 and taking further I-V measurements. The system 200 may be utilized with software to adjust these current and voltage measurements for time-varying irradiance and module inductance, as well as temperature, and light properties such as spectrum and collimation. This will enable the calculation of a power estimate for a set of standard temperatures and irradiances. Additionally, the variation of this power estimate between tests taken in an on-axis condition as well as a defined set of off-axis conditions may be used to create an estimate of acceptance angle. Such estimates should account for aspects of the tested performance of the module 202 that are artifacts of the solar simulator itself, and provide an estimate of these under solar light.

While the specification has been described in detail with respect to specific embodiments, it will be appreciated that those skilled in the art, upon attaining an understanding of the foregoing, may readily conceive of alterations to, variations of, and equivalents to these embodiments. These and other modifications and variations to the present system for simulating operation of a solar module may be practiced by those of ordinary skill in the art, without departing from the spirit and scope of the present subject matter, which is more particularly set forth in the appended claims. Furthermore, those of ordinary skill in the art will appreciate that the foregoing description is by way of example only, and is not intended to be limiting. Thus, it is intended that the present subject matter covers such modifications and variations as come within the scope of the appended claims and their equivalents.

What is claimed is:

1. A system for simulating operation of a solar module, the system comprising:
a frame for holding the solar module in a testing position;
a light source positioned adjacent to the solar module for directing light from the light source to the solar module; and
a movable assembly for simulating movement of a solar tracker system, wherein the movable assembly moves in two axes to change an incident angle of the light with respect to the testing position of the solar module.

2. The system of claim 1, further comprising a collimating optic positioned adjacent to the solar module, wherein divergent light from the light source is transformed into collimated light that is directed to the solar module.

3. The system of claim 1, wherein the movable assembly moves the frame.

4. The system of claim 1, wherein the movable assembly moves the light source.

5. The system of claim 1, wherein the movable assembly is capable of rotating in a vertical axis and a horizontal axis.

6. The system of claim 1, wherein the movable assembly is an X-Y robot device.

7. The system of claim 1, wherein the movable assembly is capable of moving the light source from a first position to a second position and the system further comprising a circuit for measuring a first characteristic of a solar module with the assembly in the first position and a second characteristic with the assembly in the second position.

8. The system of claim 7, wherein the first characteristic is an acceptance angle.

9. The system of claim 1 further comprising a circuit for measuring a characteristic of the solar module, and wherein the characteristic is power produced by reflected light on the solar module.

10. The system of claim 1, wherein the movable assembly comprises a movable inner frame and a movable outer frame.

11. The system of claim 10, wherein the movable inner frame comprises a clamping assembly for mounting the solar module.

12. The system of claim 1, wherein the movable assembly is capable of moving the solar module from a first position to a second position, and the system further comprising a circuit for measuring a first characteristic of the solar module with the movable assembly in the first position and a second characteristic of the solar module with the movable assembly in the second position.

13. The system of claim 12, wherein the first characteristic is an acceptance angle.

14. A method for simulating operation of a solar module, the method comprising the steps of:
providing a frame for holding the solar module in a testing position;
positioning a light source adjacent to the frame for directing light from the light source to the solar module; and
providing a movable assembly to simulate movement of a solar tracker system, wherein the assembly moves in two axes to change an incident angle of the light with respect to the testing position of the solar module.

15. The method of claim 14 further comprising the step of positioning a reflector across from the solar module, wherein light is directed from the light source to the reflector for reflecting light to the solar module.

16. The method of claim 14 further comprising the step of moving the frame.

17. The method of claim 14 further comprising the step of moving the light source.

18. The method of claim 14 further comprising the step of moving the movable assembly for translating the light source from a first position to a second position and providing a circuit for measuring a first characteristic of the solar module with the movable assembly in the first position and a second characteristic of the solar module with the movable assembly in the second position.

19. The method of claim 18, wherein the first characteristic is an acceptance angle.

20. The method of claim 18, wherein the second characteristic is an acceptance angle.
